(19) United States
(12) Patent Application Publication
(10) Pub. No.: US 2025/0353532 A1
(43) Pub. Date: Nov. 20, 2025

(54) OUTDOOR TROLLEY WITH MULTIPLE STATES

(71) Applicant: Quzhou Hanhu Trading Co., Ltd., Quzhou (CN)

(72) Inventors: XINWEN ZHOU, Jingdezhen (CN); XUEZHENG WU, Lanxi (CN); JIAN WU, Quzhou (CN); ZHIHUA LYU, Quzhou (CN)

(21) Appl. No.: 18/785,147

(22) Filed: Jul. 26, 2024

(30) Foreign Application Priority Data
May 15, 2024 (CN) 202421055897.3

(51) Int. Cl. B62B 3/02; B62B 3/00; B62B 5/00; B62B 5/06

(52) U.S. Cl. CPC B62B 3/02; B62B 3/002; B62B 5/0013; B62B 5/067; B62B 2301/25

(57) ABSTRACT

An outdoor trolley with multiple states is provided, which includes a bottom frame, a side frame, and a positioning rod. The bottom frame is provided with a plurality of positioning blocks; the side frame is rotatably connected to the bottom frame; the positioning rod can be detachably connected between the positioning blocks and is configured to limit the side frame. By cooperating with the positioning blocks of the bottom frame, an angle of the side frame can be adjusted through the positioning rod, thereby realizing an adjustment between a folding state, a trolley state, a recliner state, and a bed state. This enables the outdoor trolley to achieve multiple functions, suitable for various use scenarios, and improves a flexibility of use.

### CROSS-REFERENCE TO RELATED APPLICATIONS

This application claims priority to Chinese Patent Application No. 202421055897.3, filed on May 15, 2024, which is hereby incorporated by reference in its entirety.

### TECHNICAL FIELD

The present disclosure relates to the field of outdoor goods technologies, and in particular, to an outdoor trolley with multiple states.

### BACKGROUND

Nowadays, with the continuous improvement of people's living standards, self-driving tours and outdoor leisure are gradually becoming popular. People often carry a large number of items when organizing outdoor activities together. In order to solve a problem of transportation, many people choose to use an outdoor trolley.

The outdoor trolley implemented in the existing technology often only has a function of transportation, with single functionality, and cannot be used in multiple scenarios, resulting in low flexibility in use.

### SUMMARY

The technical solution adopted by the present disclosure to solve the above problems is as follows.

The present disclosure provides an outdoor trolley with multiple states, including:
a bottom frame, the bottom frame is provided with a plurality of positioning blocks;
a side frame, the side frame is rotatably connected to the bottom frame;
a positioning rod, the positioning rod is detachably connected between the positioning blocks and configured to limit the side frame.

In an embodiment of the present disclosure, the positioning blocks are provided at four corners of the bottom frame, and each positioning block is provided with a plurality of positioning slots; the positioning slots are distributed in an arc shape on a side of each positioning block; the positioning rod is detachably connected to the positioning blocks through the positioning slots.

In an embodiment of the present disclosure, the positioning rod includes a housing and a push rod provided in the housing; one end of the push rod close to the housing is provided with a pin, an end of the housing is provided with an elastic member, the elastic member is provided between the pin and the housing; one end of the elastic member is fixedly connected to an interior of the housing; the positioning rod is detachably connected between the positioning blocks by moving the push rod.

In an embodiment of the present disclosure, the housing is provided with a first sliding groove; one end of the push rod away from the pin is provided with a second through hole; an outer side of the housing is provided with a pick, the pick is provided with a third through hole; the positioning rod further includes a connecting pin that passes through the first sliding groove, the second through hole, and the third through hole; one end of the push rod away from the second through hole is provided with a second sliding groove, one end of the housing close to the pin is provided with a first through hole; the connecting pin passes through the first through hole and the second sliding groove.

In an embodiment of the present disclosure, a bottom of the bottom frame is provided with a universal wheel, an inner side of the universal wheel is rotatably connected to the positioning blocks; a torsion spring is provided between the universal wheel and the positioning blocks; the side frame is provided with a lower swing rod, two sides of the lower swing rod are respectively fitted to a connection between the positioning blocks and the universal wheel; a lower of the side frame downward extends below the connection between the positioning blocks and the universal wheel.

In an embodiment of the present disclosure, the side frame includes a first side frame and a second side frame; and a fixed rod is detachably provided between the first side frame and the second side frame; the first side frame and the second side frame both include a first bracket and a second bracket, and the first bracket is sleeved with the second bracket.

In an embodiment of the present disclosure, the positioning blocks, the first side frame and the second side frame are all provided with a clamp slot component; the clamp slot component includes a sliding chute and an arc-shaped clamp slot; two ends of the fixed rod are provided with a clamp block component; the clamp block component includes an arc-shaped clamp block and a clamp block connection rod connected to the fixed rod; a cross-sectional of the clamp block connection rod is an arc with at least one straight edge.

In an embodiment of the present disclosure, the first side frame and the second side frame are rotatably connected with a support bracket; both the first side frame and second side frame are provided with a support bracket fixing block; the support bracket is fixed to the first side frame and the second frame through the support bracket fixing block.

In an embodiment of the present disclosure, the bottom frame is provided with a connection rod, the connection rod is bent downward, and a pull rod is provided on the first side frame or the second side frame.

In an embodiment of the present disclosure, the trolley further includes a tent component, the tent component includes a tent and a tent bracket configured to support the tent, the positioning blocks are provided with a bracket insertion hole, and the tent is inserted into the bracket insertion hole through the tent bracket.

The beneficial effect of the present disclosure is that the technical solution provides an outdoor trolley with multiple states, including a bottom frame, a side frame, and a positioning rod. The bottom frame is provided with a plurality of positioning blocks; the side frame is rotatably connected to the bottom frame; the positioning rod can be detachably connected between the positioning blocks and is configured to limit the side frame. By cooperating with the positioning blocks of the bottom frame, an angle of the side frame can be adjusted through the positioning rod, thereby realizing an adjustment between a folding state, a trolley state, a recliner state, and a bed state. This enables the outdoor trolley to achieve multiple functions, suitable for various use scenarios, and improves a flexibility of use.

### BRIEF DESCRIPTION OF DRAWINGS

In order to provide a clearer explanation of the embodiments of the present disclosure or the technical solutions in the prior art, a brief introduction will be given to the accompanying drawings required for the description of the embodiments or the prior art. It is obvious that the accompanying drawings described below are only some embodiments of the present disclosure. For those skilled in the art, other drawings can be obtained based on the structures shown in these drawings without creative work.

FIG. 1 is a perspective view of an outdoor trolley with multiple states according to the present disclosure.

FIG. 2 is a perspective view of a support bracket of the outdoor trolley with multiple states according to the present disclosure.

FIG. 3 is an exploded view of the support bracket of the outdoor trolley with multiple states according to the present disclosure.

FIG. 4 is a first perspective view of positioning blocks and a universal wheel in the outdoor trolley with multiple states according to the present disclosure.

FIG. 5 is a second perspective view of the positioning blocks and universal wheel in the outdoor trolley with multiple states according to the present disclosure.

FIG. 6 is a perspective view of a side frame and universal wheel of the outdoor trolley with multiple states according to the present disclosure.

FIG. 7 is an enlarged view of B in FIG. 6.

FIG. 8 is a schematic structural diagram of a clamp slot component in the outdoor trolley with multiple states according to the present disclosure.

FIG. 9 is a schematic structural diagram of a clamp block in the outdoor trolley with multiple states according to the present disclosure.

FIG. 10 is a perspective view of the outdoor trolley with multiple states in a bed state according to the present disclosure.

FIG. 11 is a perspective view of the outdoor trolley with multiple states in a recliner state according to the present disclosure.

FIG. 12 is a perspective view of the outdoor trolley with multiple states in a folding state according to the present disclosure.

FIG. 13 is an enlarged view of A in FIG. 12.

FIG. 14 is a perspective view of a tent of the outdoor trolley with multiple states after installation according to the present disclosure.

Numeral reference: 1—bottom frame, 101—lower swing rod, 2—positioning block, 201—positioning slot, 202—torsion spring, 203—bracket insertion hole, 3—universal wheel, 4—side frame, 4a—first side frame, 4b—second side frame, 401—first bracket, 402—second bracket, 403—support bracket fixing block, 5—fixed rod, 501—arc-shaped clamp block, 502—clamp block connection rod, 503—straight edge, 6—support bracket, 7—pull rod, 8—positioning rod, 801—housing, 8011—first through hole, 802—first sliding groove, 803—push rod, 8031—second through hole, 8032—second sliding groove, 804—pick, 8041—third through hole, 805—elastic member, 806—pin, 9—connection rod, 10a—tent, 10b—tent bracket, 11—clamp slot component, 1101—sliding chute, 1102—arc-shaped clamp slot.

### DESCRIPTION OF EMBODIMENTS

In order to enable those skilled in the art to better understand the technical solution of the present application, the following will provide a clear and complete description of the technical solution in the embodiments of the present application in combination with the accompanying drawings. Obviously, the described embodiments are only a part of the embodiments of the present application, not all of them. Based on the embodiments in the present disclosure, all other embodiments obtained by those skilled in the art without creative work are within the protection scope of the present application.

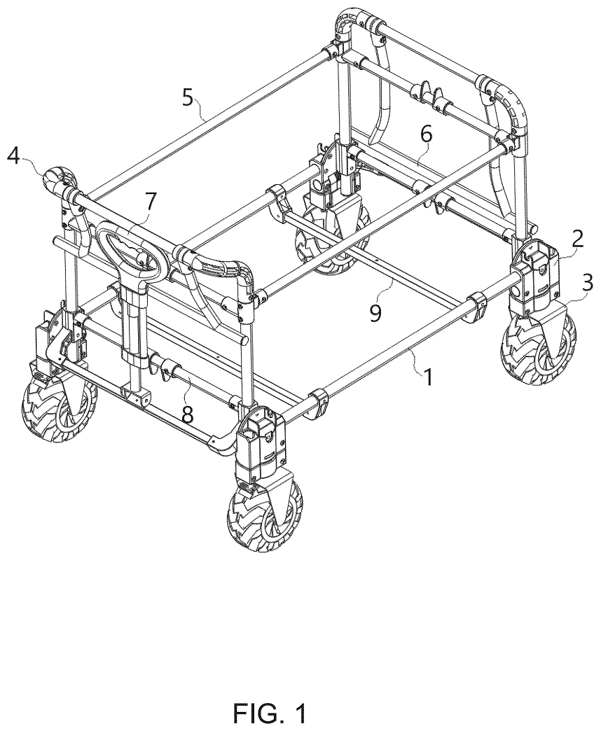

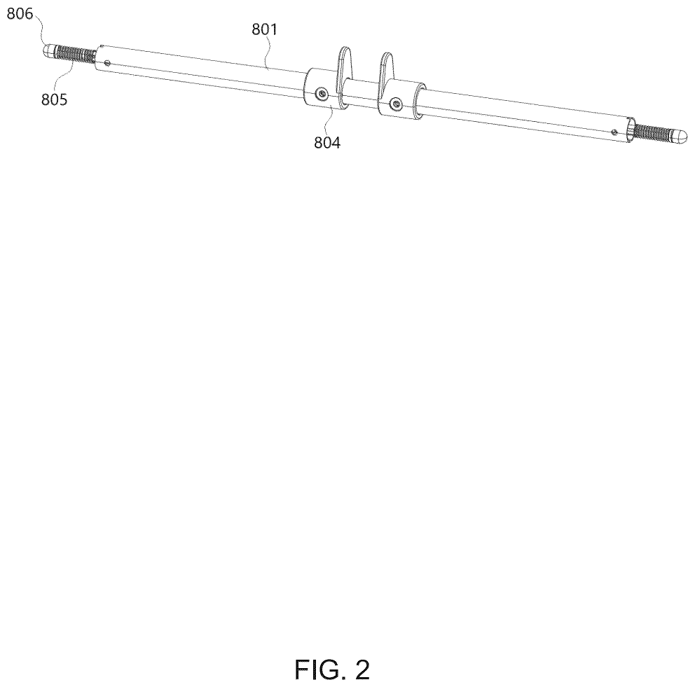

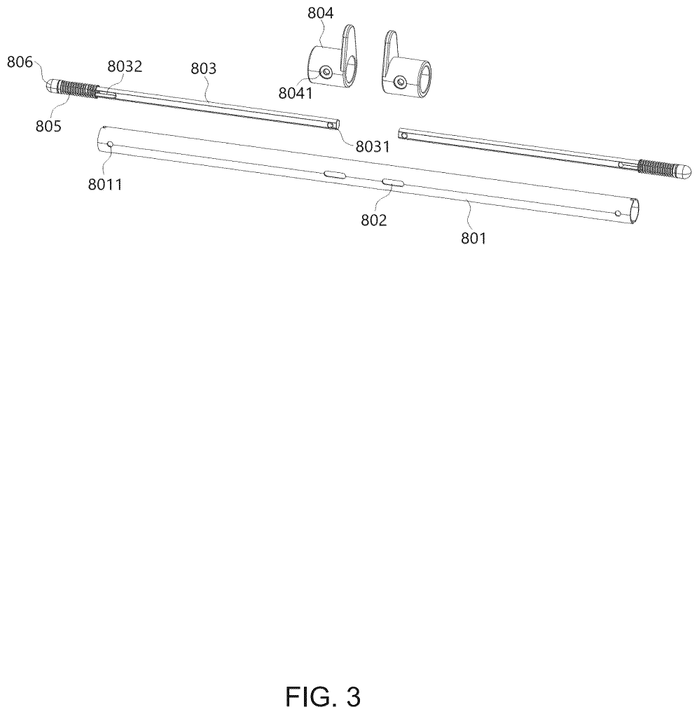

Referring to FIGS. 1-3 of the specification, an outdoor trolley with multiple states includes a bottom frame 1, a side frame 4, and a positioning rod 8. The bottom frame 1 is provided with a plurality of positioning blocks 2; the side frame 4 is rotatably connected to the bottom frame 1; the positioning rod 8 can be detachably connected between the positioning blocks 2, and the positioning rod 8 is configured to limit the side frame 4. By cooperating with the positioning blocks 2 of the bottom frame 1, an angle of the side frame 4 can be adjusted through the positioning rod 8, thereby realizing an adjustment between a folding state, a trolley state, a recliner state, and a bed state, rendering the outdoor trolley achieves multiple functions and suitable for various usage scenarios.

In an implementation, the positioning blocks 2 are provided at four corners of the bottom frame 1, a plurality of positioning slots 201 are provided on each positioning block 2. The positioning slots 201 are distributed in an “arc” shape on a side of each positioning block 2. The positioning rod 8 is detachably connected to the positioning blocks 2 through the positioning slots 201. By providing with a plurality of positioning slots 201, a certain angle is formed between the positioning slots 201, so that the positioning rod 8 can be fixed at various angles on the positioning blocks 2, achieving the fixation of various angles on the side frame 4.

In an implementation, the positioning rod 8 includes a housing 801 and a push rod 803 provided in the housing 801. One end of the push rod 803 close to the housing 801 is provided with a pin 806, and an elastic member 805 is provided in an end point of the housing 801. The elastic member 805 is provided between the pin 806 and the housing 801. One end of the elastic member 806 is fixedly connected to an interior of the housing 801. The positioning rod 8 is detachably connected to the positioning blocks 2 by moving the push rod 803. The housing 801 is provided with a first sliding groove 802, and one end of the push rod 803 away from the pin 806 is provided with a second through hole 8031. An outer side of the housing 801 is sleeved with a pick 804, the pick 804 is provided with a third through hole 8041. The positioning rod 8 further includes a connecting pin that passes through the first sliding groove 802, the second through hole 8031 and the third through hole 8041. The pick 804 is connected with the push rod 803 and slides within the first sliding groove 802 of the housing 801 by the connecting pin. One end of the push rod 803 away from the second through hole 8031 is provided with a second sliding groove 8032. One end of the housing 801 close to the pin 806 is provided with a first through hole 8011. The connecting pin passes through the first through hole 8011 and the second sliding groove 8032. The elastic member 805 keeps the pin protruding from an outside of the housing 801, and by moving the push rod 803, the push rod 803 is driven to contract inward, thereby causing the pin 806 to be detached from the positioning slot 201, completing a disassembly of the positioning rod 8. When installation, by simply moving the push rod 803, rendering the pin 806 be retracted. When the pin 806 is aligned with the positioning slots 201, the push rod 803 is released, due to a rebound of the elastic member 805, the pin 806 extends into the positioning slots 201, thereby completing the installation. In addition, the plurality of positioning slots 201 can be replaced with a single set of arc-shaped slots.

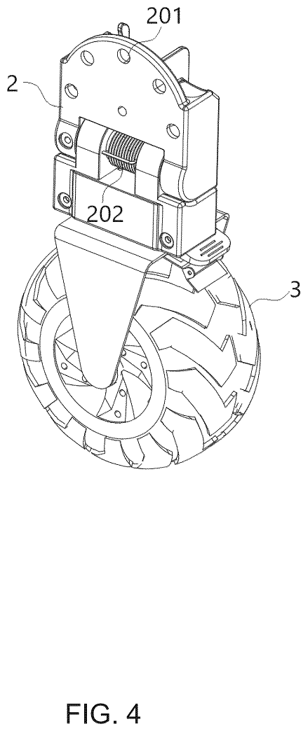

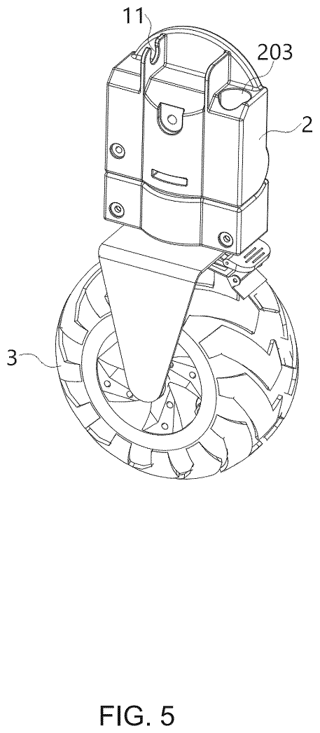

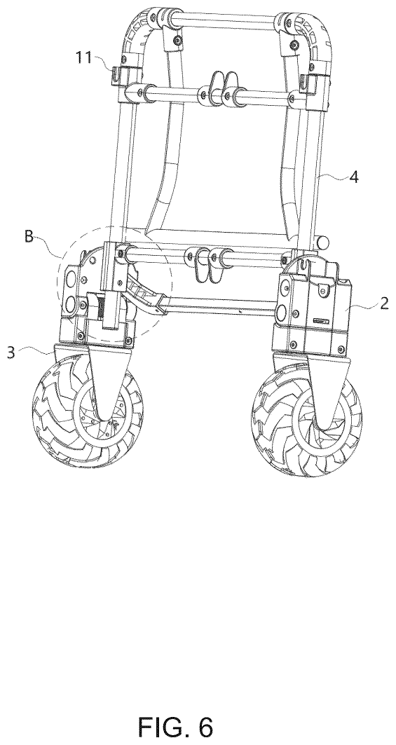

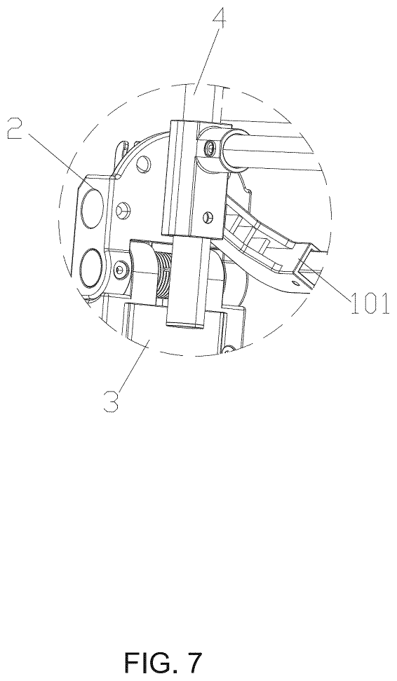

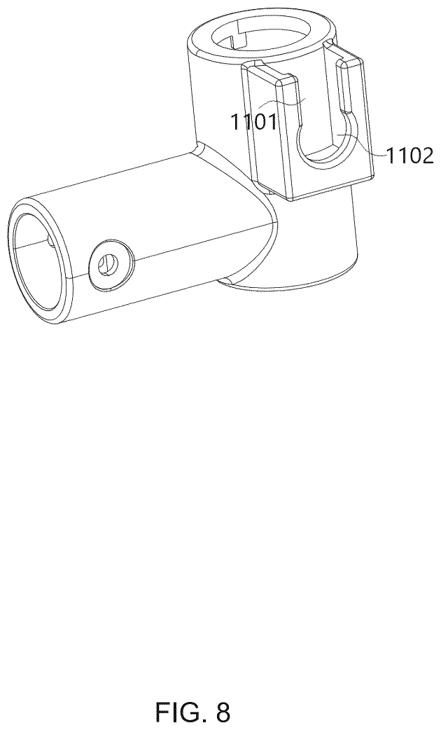

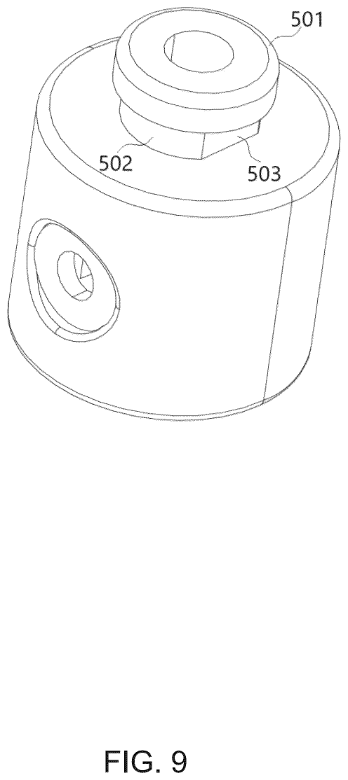

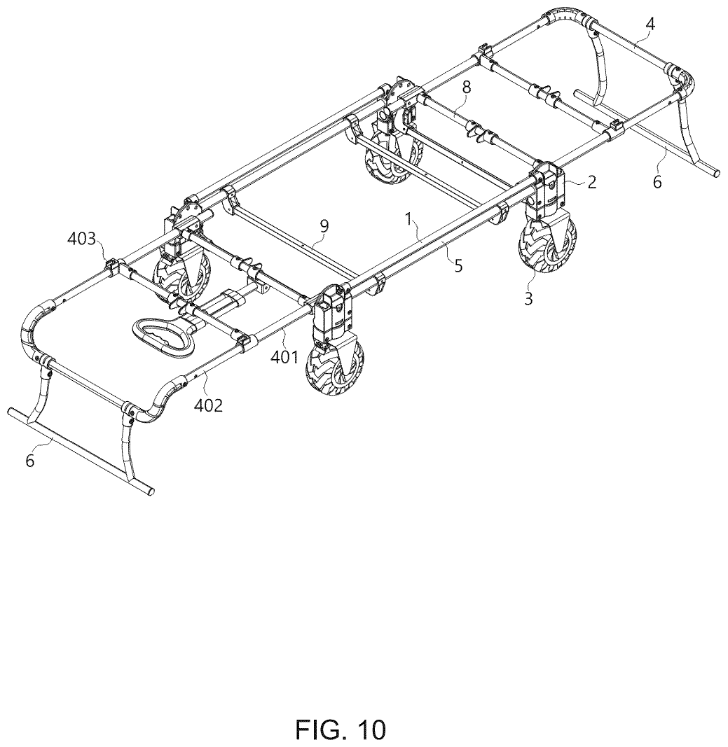

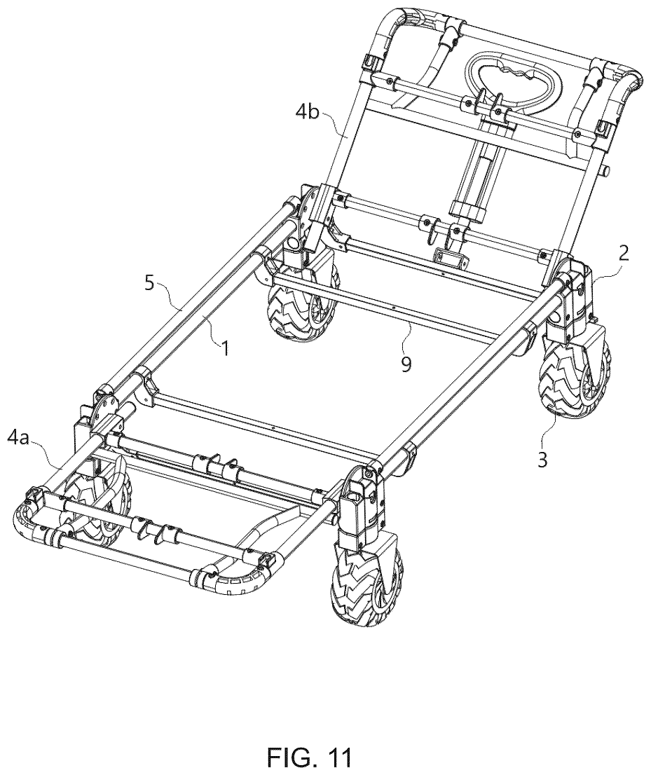

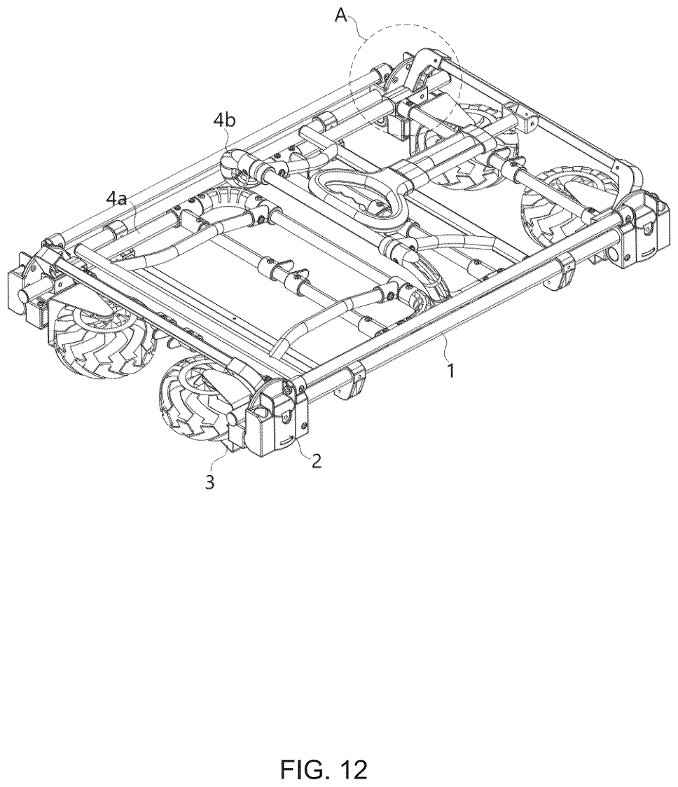

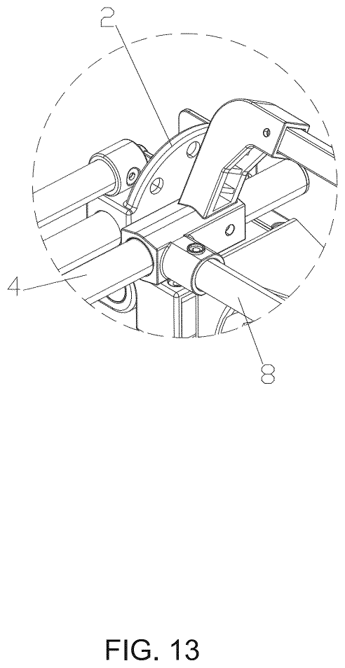

As shown in FIGS. 4-13 of the specification, in an implementation, a bottom of the bottom frame 1 is provided with a universal wheel 3, an inner side of the universal wheel 3 is rotatably connected to the positioning blocks 2. A torsion spring 202 is provided between the universal wheel 3 and the positioning blocks 2; a lower swing rod 101 is provided on the side frame 4. Two sides of the lower swing rod 101 are respectively fitted with a connection between the positioning blocks 2 and the universal wheel 3. A lower of the side frame 4 extends below the connection between the positioning blocks 2 and the universal wheel 3. When the torsion spring 202 is not subjected to an external force, the universal wheel 3 and the positioning blocks 2 are in a bent state. When the side frame 4 forms an angle with the bottom frame 1 in a recliner and a bed state, the lower swing rod 101 is fitted to the connection between the positioning blocks 2 and the universal wheel 3 so as to prevent the positioning blocks 2 and the universal wheel 3 from resorting and bending. In the trolley state, the lower swing rod 101 is detached from the connection between the positioning blocks 2 and the universal wheel 3. At this time, the lower of the side frame 4 is rotated to the connection between the positioning blocks 2 and the universal wheel 3, so that the positioning blocks 2 and the universal wheel 3 are in an upright state. In the folding state, both the side frame 4 and the lower swing rod 101 are detached from the connection between the positioning blocks 2 and the universal wheel 3; the positioning blocks 2 and the universal wheel 3 are restoration under an action of the torsion spring 202. In the bent state, the volume is reduced, and it facilitates to store.

In an implementation, the side frame 4 includes a first side frame 4a and a second side frame 4b. A fixed rod 5 is detachably provided between the first side frame 4a and the second side frame 4b. The first side frame and the second side frame both include a first bracket 401 and a second bracket 402. The first bracket 401 is sleeved with the second bracket 402, and lengths of the first side frame and second side frame can be adjusted by moving a position of the first bracket 401 relative to the second bracket 402.

In an implementation, the positioning blocks 2, the first side frame and the second side frame are both provided with a clamp slot component 11, the clamp slot component 11 includes a sliding chute 1101 and an arc-shaped clamp slot 1102. Two ends of the fixed rod 5 are provided with a clamp slot component, the clamp slot component includes an arc-shaped clamp block 501 and a clamp block connection rod 502 connected to the fixed rod 5. A cross-sectional of the clamp block connection rod 502 is an arc with at least one straight edge 503. When the fixed rod 5 is in use, the two ends of the fixed rod 5 are connected between the first side frame and the second side frame through the clamp slot component 11. When the fixed rod 5 is stored, the two ends of the fixed rod 5 are fixed to the positioning blocks through the clamp slot component 11. The arc-shaped clamp block 501 is inserted into the arc-shaped clamp slot 1102 through the clamp block connection rod 502. During insertion, the straight edge 503 on the clamp block connection rod 502 is aligned with the sliding chute 1101 and placed in the arc-shaped clamp slot 1102. Then the clamp block connection rod 502 is rotated to complete the fixation of the fixed rod 5.

Specifically, the first side frame 4a and the second side frame 4b are rotatably provided with a support bracket 6; both the first side frame 4a and the second side frame 4b are provided with a support bracket fixing block 403. The support bracket 6 is fixed to the first side frame 4a and the second side frame 4b through the support bracket fixing block 403.

Specifically, the bottom frame 1 is provided with a connection rod 9, which is bent downwards. Items are placed on the bottom frame 1 through the connection rod 9. The connection rod is bent downwards so as to increase a storage space. The first side frame 4a or the second side frame 4b is provided with a pull rod 7, the push rod 7 can be used to pull the trolley, rendering it easy to use.

In addition, a side and a bottom of the trolley are provided with a covering part, the covering part may be a waterproof cloth, and a shape of the covering part can change with the state of the trolley.

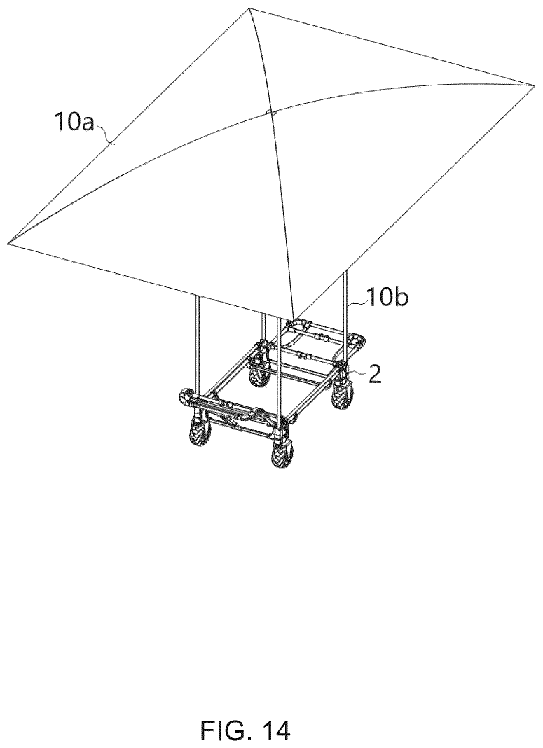

As shown in FIG. 14 of the specification, the trolley further includes a tent component, the tent component includes a tent 10a and a tent bracket 10b for supporting the tent. The positioning blocks 2 are provided with a bracket insertion hole 203, and the tent 10a is inserted into the bracket insertion hole 203 through the tent bracket 10b. When the tent needs to be used in a usage scenario, the tent is stretched open and fixed on the positioning blocks 2 through the tent bracket 10b.

From the above description, it can be seen that the embodiments of the present disclosure have achieved the following technical effects:

This technical solution provides an outdoor trolley with multiple states, including a bottom frame, a side frame, and a positioning rod. The bottom frame is provided with a plurality of positioning blocks; the side frame is rotatably connected to the bottom frame; the positioning rod can be detachably connected between the positioning blocks and is configured to limit the side frame. By cooperating with the positioning blocks of the bottom frame, an angle of the side frame can be adjusted through the positioning rod, thereby realizing the adjustment between the folding state, trolley state, recliner state, and bed state. This enables the outdoor trolley to achieve multiple functions, suitable for various use scenarios, and improves a flexibility of use.

It should be noted that terms used here are only intended to describe specific embodiments and are not intended to limit the exemplary embodiments according to the present application. As used herein, unless otherwise explicitly stated in the specification, a singular form is also intended to include a plural form. Additionally, it should be understood that when the terms “including” and/or “having” are used in this specification, they indicate a presence of features, steps, operations, devices, components, and/or combinations thereof.

Unless otherwise specified, a relative arrangement, numerical expressions, and values of the components and steps described in these embodiments do not limit the scope of the present application. At the same time, it should be understood that for ease of description, the dimensions of the various parts shown in the attached drawings are not drawn according to an actual proportional relationship. For technologies, methods, and equipment known to ordinary technical personnel in related fields, detailed discussions may not be made, but in appropriate circumstances, such technologies, methods, and equipment should be considered as a part of the specification. In all the examples shown and discussed here, any specific value should be interpreted as merely illustrative and not limitation. Therefore, other examples of exemplary embodiments may have different values. It should be noted that similar labels and letters represent similar items in the following drawings. Therefore, once an item is defined in one drawing, it does not need to be further discussed in subsequent drawings.

In the description of the present application, it should be understood that a directional word such as “front”, “back”, “up”, “down”, “left”, “right”, “horizontal”, “vertical”, “upright”, transverse”, “top”, and “bottom” usually indicate directional or positional relationships based on the directional or positional relationships shown in the accompanying drawings. This is only for a convenience of describing the present application and simplifying the description. Unless otherwise stated, these directional words do not indicate or imply that the device or component referred to must have a specific orientation or be constructed and operated in a specific orientation, and therefore cannot be understood as limiting the protection scope of the present application; besides, the directional words “inside” and “outside” refer to inner and outer contours relative to each component itself.

It should be understood that when a component is referred to as “on” or “connected” to another component, it can be directly on or directly connected to the other component, or indirectly connected by an inserted component between the two. On the contrary, when a component is referred to as “directly” on or “directly connected” to another component, there is no inserted component between the two.

In addition, it should be noted that in the description of the present disclosure, the use of words such as “first” and “second” to define components is only for the purpose of distinguishing the corresponding components. If not otherwise stated, the above words do not have a special meaning and therefore cannot be understood as limiting the protection scope of the present application. In the description of the present disclosure, unless otherwise specified, the meaning of “multiple” refers to two or more.

The above is preferred embodiments of the present disclosure. It should be pointed out that for those skilled in the art, some improvements and embellishments can be made without departing from the principles of the present disclosure. These improvements and embellishments are also considered within the protection scope of the present disclosure.

What is claimed is:

1. An outdoor trolley with multiple states, comprising:
a bottom frame, the bottom frame is provided with a plurality of positioning blocks;
a side frame, the side frame is rotatably connected to the bottom frame;
a positioning rod, the positioning rod is detachably connected between the positioning blocks and configured to limit the side frame.

2. The outdoor trolley with multiple states according to claim 1, wherein the positioning blocks are provided at four corners of the bottom frame, and each positioning block is provided with a plurality of positioning slots; the positioning slots are distributed in an arc shape on a side of each positioning block; the positioning rod is detachably connected to the positioning blocks through the positioning slots.

3. The outdoor trolley with multiple states according to claim 2, wherein the positioning rod comprises a housing and a push rod provided in the housing; one end of the push rod close to the housing is provided with a pin, an end of the housing is provided with an elastic member, the elastic member is provided between the pin and the housing; one end of the elastic member is fixedly connected to an interior of the housing; the positioning rod is detachably connected between the positioning blocks by moving the push rod.

4. The outdoor trolley with multiple states according to claim 3, wherein the housing is provided with a first sliding groove; one end of the push rod away from the pin is provided with a second through hole;
an outer side of the housing is provided with a pick, the pick is provided with a third through hole;
the positioning rod further comprises a connecting pin that passes through the first sliding groove, the second through hole, and the third through hole;
one end of the push rod away from the second through hole is provided with a second sliding groove, one end of the housing close to the pin is provided with a first through hole;
the connecting pin passes through the first through hole and the second sliding groove.

5. The outdoor trolley with multiple states according to claim 4, wherein a bottom of the bottom frame is provided with a universal wheel, an inner side of the universal wheel is rotatably connected to the positioning blocks; a torsion spring is provided between the universal wheel and the positioning blocks;
the side frame is provided with a lower swing rod, two sides of the lower swing rod are respectively fitted to a connection between the positioning blocks and the universal wheel;
a lower of the side frame downward extends below the connection between the positioning blocks and the universal wheel.

6. The outdoor trolley with multiple states according to claim 5, wherein the side frame comprises a first side frame and a second side frame; and a fixed rod is detachably provided between the first side frame and the second side frame;
the first side frame and the second side frame both comprise a first bracket and a second bracket, the first bracket is sleeved with the second bracket.

7. The outdoor trolley with multiple states according to claim 6, wherein the positioning blocks, the first side frame and the second side frame are all provided with a clamp slot component; the clamp slot component comprises a sliding chute and an arc-shaped clamp slot;
two ends of the fixed rod are provided with a clamp block component; the clamp block component comprises an arc-shaped clamp block and a clamp block connection rod connected to the fixed rod;
a cross-sectional of the clamp block connection rod is an arc with at least one straight edge.

8. The outdoor trolley with multiple states according to claim 7, wherein the first side frame and the second side frame are rotatably connected with a support bracket; both the first side frame and the second side frame are provided with a support bracket fixing block; the support bracket is fixed to the first side frame and the second frame through the support bracket fixing block.

9. The outdoor trolley with multiple states according to claim 8, wherein the bottom frame is provided with a connection rod, the connection rod is bent downward, and a pull rod is provided on the first side frame or the second side frame.

10. The outdoor trolley with multiple states according to claim 1, wherein the trolley further comprises a tent component, the tent component comprises a tent and a tent bracket configured to support the tent, the positioning blocks are provided with a bracket insertion hole, and the tent is inserted into the bracket insertion hole through the tent bracket.
